(19) United States
(12) Patent Application Publication
(10) Pub. No.: US 2016/0122097 A1
(43) Pub. Date: May 5, 2016

(54) TAMPER RESISTANT CONTAINER

(71) Applicant: Chudy Group, LLC, Powers Lake, WI (US)

(72) Inventors: Duane S. Chudy, Lincolnshire, IL (US); Michael Jehn, Waukesha, WI (US)

(73) Assignee: CHUDY GROUP, LLC, Powers Lake, WI (US)

(21) Appl. No.: 14/527,739

(22) Filed: Oct. 29, 2014

(51) Int. Cl. B65D 55/02; B65D 83/04; B65D 43/22; A61J 7/00; B65D 43/14

(52) U.S. Cl. CPC B65D 55/02; A61J 7/0076; B65D 43/14; B65D 43/22; B65D 83/0409

(57) ABSTRACT

A tamper resistant container for secure storage and dispensing of objects therefrom and method includes a housing having an inlet, an outlet and a lid which opens and closes the inlet, a dispensing mechanism within the housing to position an object for dispensing from the container, a base including a drive mechanism and a pin which cooperates with at least one of the housing and the base. The container includes a moveable plate positioned with respect to the outlet for opening and closing the outlet, the moveable plate being biased in a closed and secure position when the housing is removed from the base. The moveable plate moves to an open position when the housing is positioned on the base and the pin cooperates with the moveable plate to allow an object to be dispensed from the tamper resistant container.

### FIELD

The field relates generally to tamper resistant containers and, more particularly, to tamper resistant containers for use in controlled environments.

### BACKGROUND

In pharmacy, retail, hospital, long-term-care and mail order medicament dispensing, a large number of different prescription orders must be fulfilled. The prescription orders may include one or more prescription for single-dose medications or medicaments, such as tablets. Fulfillment as used herein refers to the process of handling and executing customer orders. The term “tablets” and “medicaments” as used herein should be understood as being generic to tablets, capsules, caplets and any other solid-dose medication types including prescription and non-prescription medications, products and the like. The term “container” as used herein should be understood to include any type of canister or enclosure for medicaments such as portable containers, storage modules, cassettes and similar canisters or enclosures for dispensing, storing or transporting medicaments including controlled substances.

The dispensing, transport and storage of such medicaments is typically regulated by pharmacy boards on federal and state levels which require compliance with certain security measures in dispensing, transporting and otherwise handling medicaments. Federal and state regulations may include requiring securely locking medicaments including all controlled substances in safe and secure containers, cabinets or the like. Such federal and state regulations may also require storing, transporting or otherwise handling such medicaments, including controlled substances, in secure tamper resistant containers in regulated environments such as prisons, penitentiaries, mental facilities and other governmental institutions.

Automatic vial filling machines and other types of medicament filling, dispensing and counting machines are used in pharmacy locations including regulated environments to dispense, store and transport bulk medicaments in removable storage modules including cassettes and other portable containers or canisters. Periodically, it in necessary to transport medicaments or store such medicaments in portable containers for future use. With existing machines using such portable containers, there is no control or security of the portable containers when they are removed from the filling, dispensing or counting machine for transport, refilling, loading, storage or for any other reason. As a result, there is a chance that unauthorized personnel could gain access to the medicaments, contaminate the medicaments or affect the correct quantity of medicaments in such portable containers. This is particularly true in regulated environments including governmental facilities as noted above.

For example, when a portable container is removed from the machine for transport or storage, the pharmacy personnel or other clerical staff may handle the container. Such personnel may be able to gain access to the medicaments in the portable containers in violation of the federal or state regulations.

In the case of storing the portable containers, a specific quantity may have been counted and verified for the particular portable container. If the portable container was accessible by pharmacy personnel or others and was not tamper evident or secure, unauthorized access may have occurred. The count could also have been impacted and no longer be correct. Without properly securing the inlet and the outlet of the container which may include tamper resistant or tamper evident features, there is no certainty that the medicaments were not tampered with or dispensed in an unauthorized manner during handling, transport or storage, or that the medicament count remains correct.

It would be an improvement in the art to provide a tamper resistant container and method of dispensing objects, including medicaments, therefrom which would secure the portable container during transport, storage or other activity while removed from the dispensing system. Such an improved tamper resistant container and method of dispensing would provide an increased likelihood that the container remained secure and not tampered with during removal from the system, including during transport, refilling, returning to stock, storage of unused medicaments, and such other pharmacy activities. Such an improved tamper resistant container and method of dispensing would contribute to the improvement and quality of patient care.

### SUMMARY

A tamper resistant container for secure storage and dispensing of objects and a method of dispensing objects from a secure container are described herein. The tamper resistant container includes a housing having an inlet, an outlet and a lid which opens and closes the inlet. A dispensing mechanism within the housing may be included to position an object, including medicaments, for dispensing from the container. The tamper resistant container may also include a base with a drive mechanism. A pin such as an activation pin may be included which cooperates with the housing or with the base. The tamper resistant container may also include a moveable plate positioned with respect to the outlet for opening and closing the outlet, the moveable plate being biased in a closed position when the housing is removed from the base. The moveable plate may move to an open position when the housing is positioned on the base and the pin cooperates with the moveable plate to allow an object to be dispensed from the tamper resistant container.

In an embodiment, the tamper resistant container may include a lock to secure the moveable plate in the closed position. In a further embodiment the lock may include a lever which releases the moveable plate for movement when the pin is engaged with the moveable plate. The lock may also include a leaf spring with an arm which releases the moveable plate for movement when the pin engages the arm.

In an additional embodiment, the tamper resistant container may also include a secure lid affixed to the inlet of the tamper resistant container. The lid may be locked to the tamper resistant container. In yet another embodiment, the tamper resistant container may include a cam surface which cooperates with the moveable plate for controllably opening the outlet through movement of the moveable plate. A biasing force such as a spring bias may be included to maintain the moveable plate in the closed position when the housing is removed from the base. In a further embodiment, the spring bias may be supplied by a spring which provides controlled closing of the outlet when the housing is removed from the base. The spring may maintain the moveable plate in the closed position when the housing is removed from the base and provides controlled movement of the plate to the open position when the housing is placed onto the base.

In an additional embodiment, the tamper resistant container may include a spring and a cam surface which cooperate with the moveable plate to controllably open and close the moveable plate with respect to the outlet. In yet another embodiment, the spring, the cam surface and the pin may all cooperate to position the moveable plate in the open and the closed position.

A method of dispensing objects from a secure tamper resistant container is also described. The method includes providing a housing having an inlet, an outlet and a lid which opens and closes the inlet and providing a dispensing mechanism within the housing to position an object for dispensing from the container. The method also includes providing a base including a drive mechanism, a moveable plate positioned with respect to the outlet and a pin which cooperates with the moveable plate. The method includes placing the housing onto the base such that the pin allows the moveable plate to move from a closed position to an open position to open and allow access to the outlet of the tamper resistant container.

In an other embodiment, the method includes locking the moveable plate in the closed position. The method may also include locking the moveable plate in the closed position by providing a lever which secures the moveable plate in the closed position, and releasing the lever allowing the moveable plate to move from the closed position.

In a further embodiment, the method provides for locking the moveable plate in the closed position with a leaf spring having an arm which releases the moveable plate for movement when the pin is engaged with the arm. In yet another embodiment, the method provides for locking the lid to cover the inlet and secure the tamper resistant container. The method may also provide a cam surface which cooperates with the moveable plate to provide controllable opening of the outlet through movement of the moveable plate. In yet another embodiment, the method provides a biasing force such as a spring bias to maintain the moveable plate in the closed position when the housing is removed from the base. The method may also provide a spring bias to maintain the moveable plate in the closed position when the housing is removed from the base and to control movement of the plate to the open position when the housing is placed onto the base. In addition the method may provide a spring bias and a cam surface which cooperate with the pin and the moveable plate to controllably move the moveable plate between the closed position and the open position.

### BRIEF DESCRIPTION OF THE DRAWINGS

Exemplary medicament delivery and replenishment systems and methods including controlling medicament dispensing from a tamper resistant portable container may be understood by reference to the following description taken in conjunction with the accompanying drawings, in which like reference numbers identify like elements throughout the different views. The drawings are not necessarily to scale, emphasis instead being placed upon illustrating the principles of the disclosure. In the accompanying drawings:

FIG. 1 is a perspective view of an exemplary medicament dispensing machine including an embodiment of the inventive tamper resistant container and method for secure storing and dispensing of objects therefrom;

FIG. 2 is an enlarged perspective view of a container dispensing unit with a housing positioned on a base as shown in FIG. 1;

FIG. 3 is a perspective view of the base of FIG. 2 with the housing and dispensing unit removed;

FIG. 4 is an exploded perspective view showing the engagement of the base and dispensing unit;

FIG. 5 is a perspective view of a portion of a locking plate mechanism showing cam surfaces;

FIG. 6 is a section view showing movement of the dispensing unit toward the base;

FIG. 7 is a section view showing initial engagement of the base with the dispensing unit;

FIG. 8 is an enlarged detail of a pin engaging with a locking lever taken along detail portion 8-8 of FIG. 7;

FIG. 9 is an enlarged detail of the pin releasing the locking lever;

FIG. 10 is section view showing the pin moving along the cam surface and opening the locking plate mechanism;

FIG. 11 is section view showing the locking plate mechanism in the fully open position;

FIG. 12 is a perspective view in section showing the medicaments in position for dispensing with the locking plate mechanism closed;

FIG. 13 is a perspective view in section showing the pin moving along the cam surface and opening the locking plate mechanism;

FIG. 14 is a perspective view in section showing the locking plate mechanism fully open and dispensing medicaments; and

FIG. 15 is a perspective view showing an embodiment of the tamper resistant container with the lid secured and locked thereon.

### DETAILED DESCRIPTION

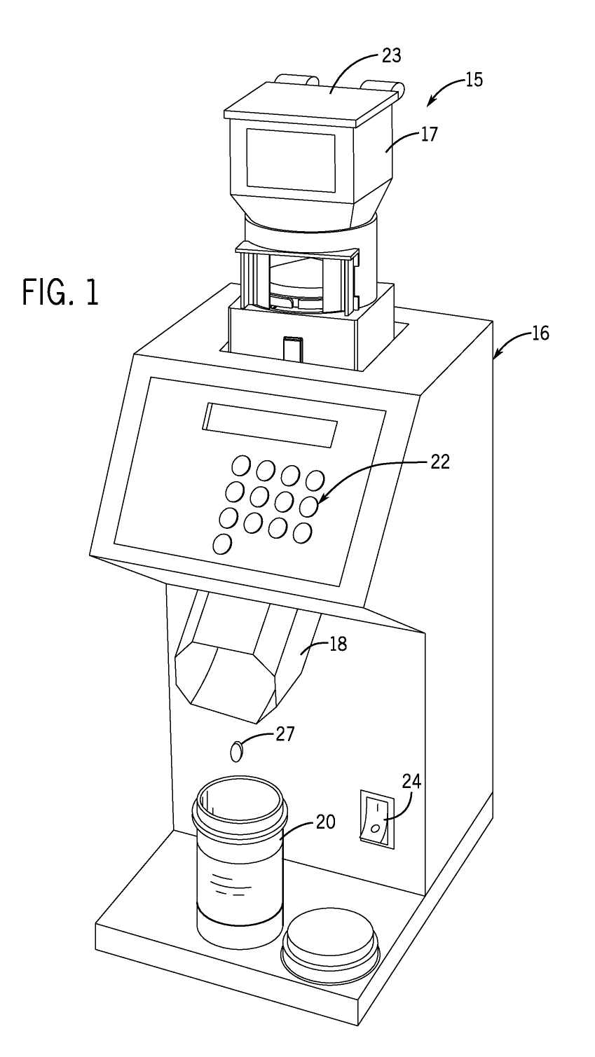

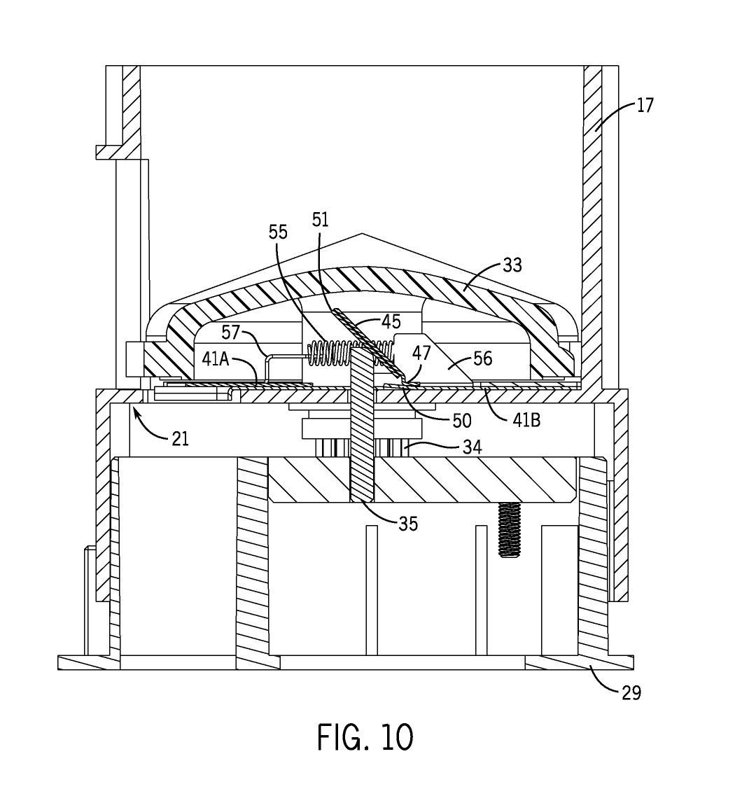

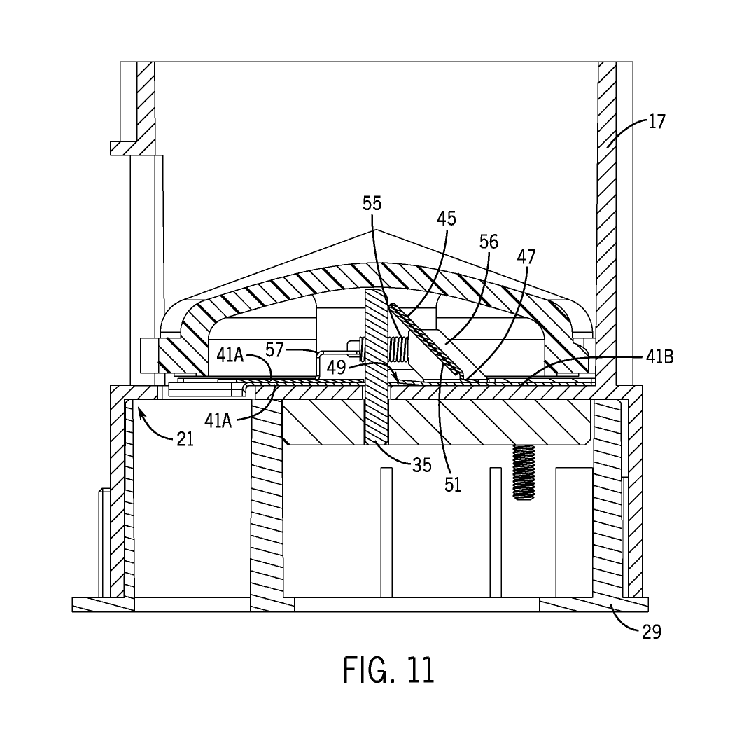

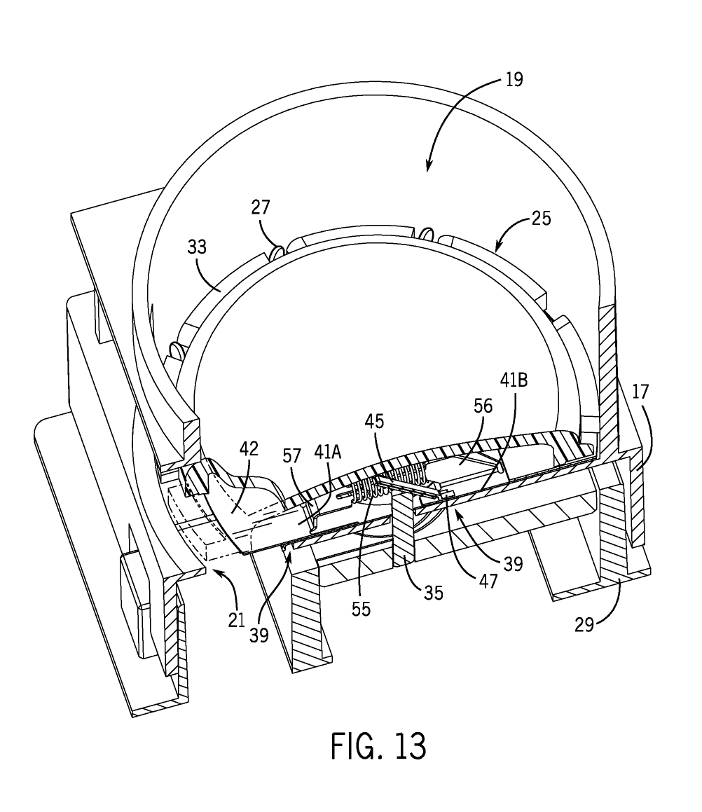

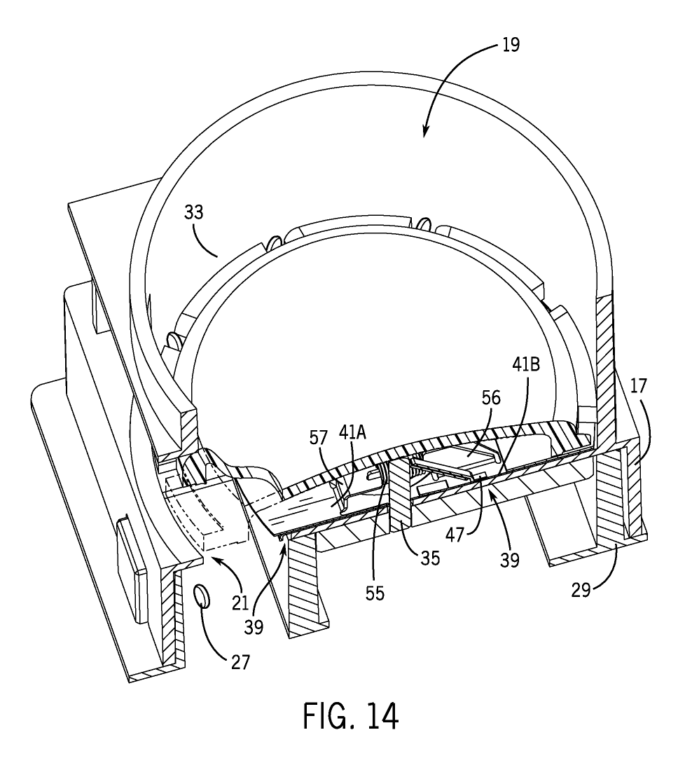

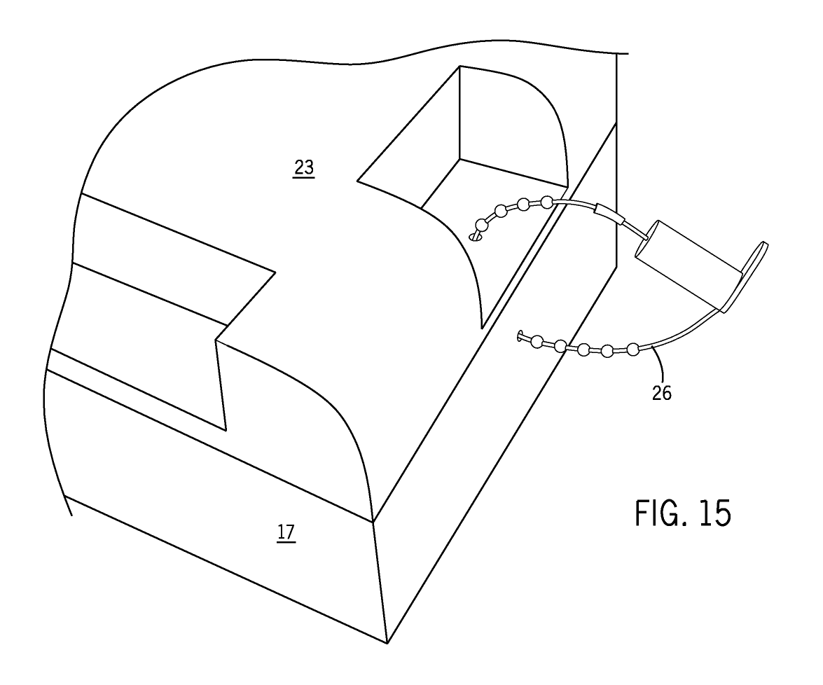

Referring first to FIGS. 1-15, an exemplary tamper resistant container 15 including a method for dispensing objects including medicaments therefrom is illustrated. As can be seen in FIG. 1, tamper resistant container 15 includes a housing 17 having an inlet 19, and outlet 21, and a lid 23. Lid 23 may be positioned over inlet 19 and move between an open position and a closed position which opens and closes inlet 19. Lid 23 may also include a locking mechanism such as zip tie 26 which securely locks lid 23 to housing 17 (see FIG. 15). Use of zip tie 26 provides the user with evidence of any potential tampering with the contents of the tamper resistant container 15. It may be appreciated that a variety of tamper evident closures can be used to secure and notify the user of any potential access to or alteration of the contents of the tamper resistant container 15, including but not limited to zip ties, tamper evident tape, a lock mechanism or similar security devices.

As illustrated in FIG. 1, dispensing machine 16 includes tamper resistant container 15 from which medicament 27 is dispensed through dispensing chute 18 into vial 20. Various controls 22 provide user adjustments and programming of the dispensing machine 16 which can be turned on and off through power switch 24.

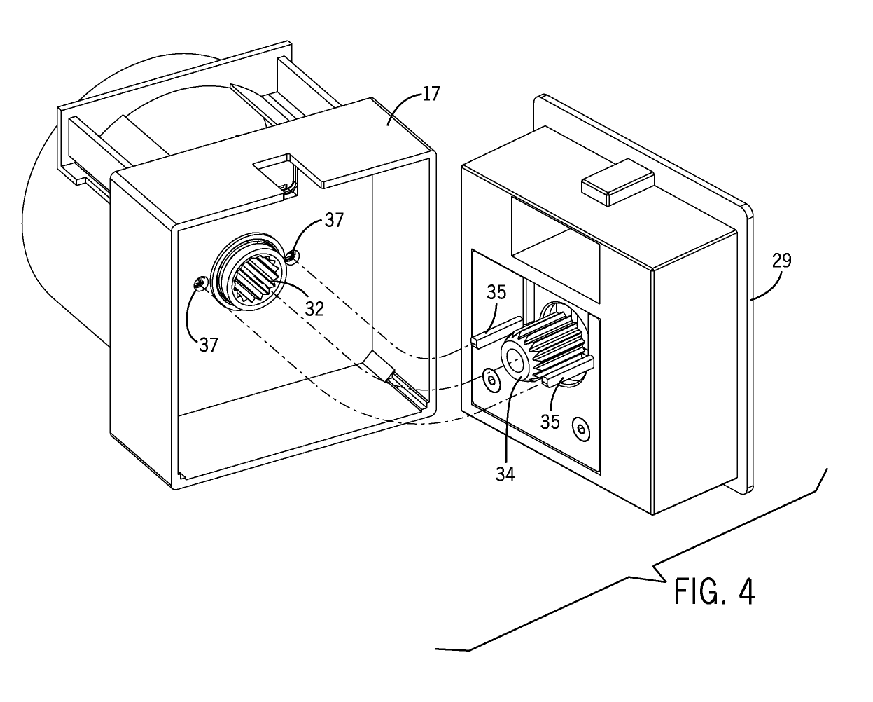

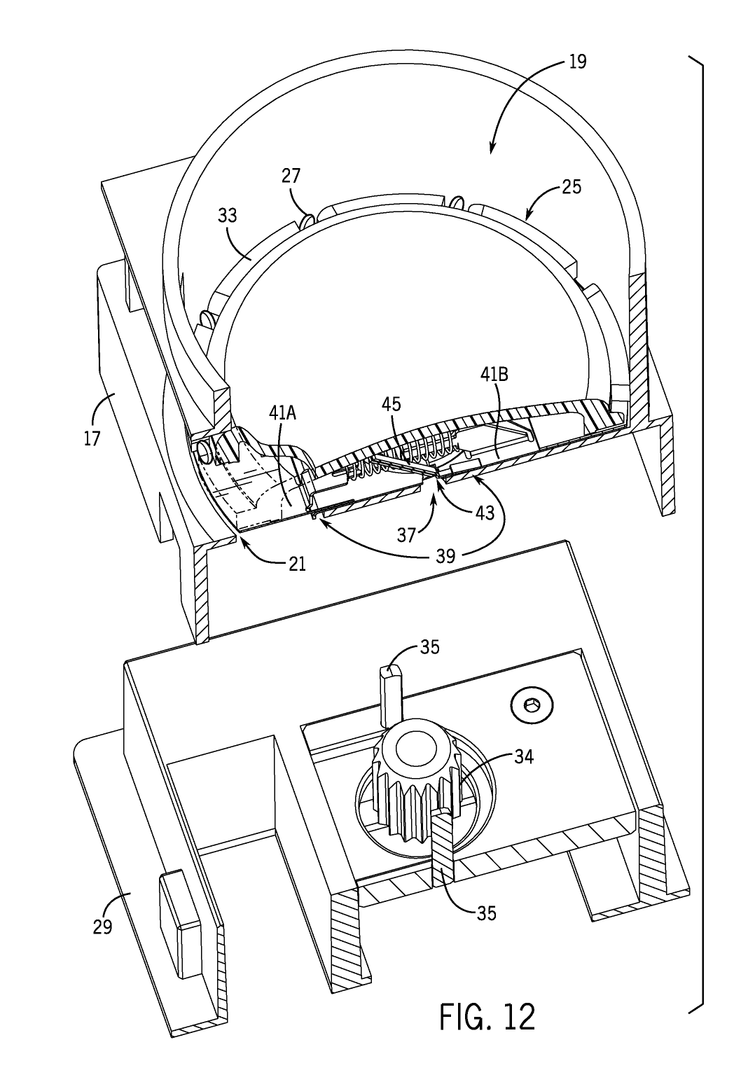

As can be seen in FIGS. 12-14, a dispensing mechanism 25 is included within housing 17 to position an object such as medicament 27 for dispensing from the tamper resistant container 15. A base such as motor base 29 is provided which may include a drive mechanism such as motor (not shown). In a preferred embodiment as shown, housing 17 is mounted on motor base 29 and motor base 29 engages with dispensing mechanism 25 (see FIG. 12) in housing 17. As is illustrated in FIG. 4, housing 17 includes a receiver 32 which accepts rotating gear 34 upon positioning motor base 29 with respect to housing 17. Dispensing mechanism 25 includes a positioning member such as turntable 33 for moving medicament 27 into position for dispensing. Rotating gear may be powered by motor (not shown) in motor base 29 to rotate turntable 33 when housing 17 is positioned on motor base 29 for operation.

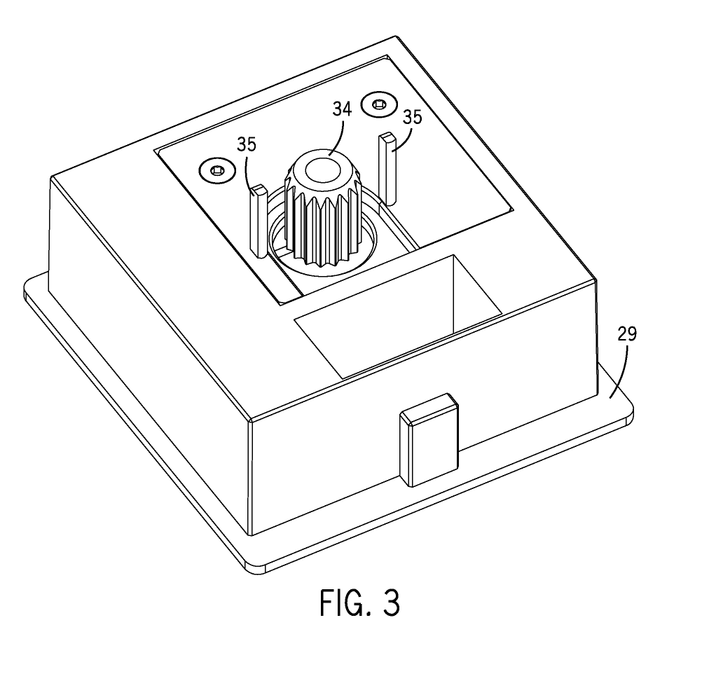

As shown in FIGS. 3, 4, and 6-14, a pin such as activation pin 35 is positioned for engagement with housing 17 of tamper resistant container 15. Activation pin 35 is positioned within aperture 37 on housing 17 to provide for operation of the tamper resistant container 15 to dispense objects including medicament 27 from outlet 21 and into chute 18.

To facilitate secure containment of medicaments according to the current federal and state regulations, a moveable plate such as plate assembly 39 is included and at least a portion of plate assembly 39 is positioned over outlet 21 of housing 17. In an exemplary embodiment, plate assembly 39 includes two sections 41A, 41B that are positioned to move with respect to one another to an open position and a closed position when housing 17 is positioned on motor base 29 and removed therefrom, respectively. In the illustrated preferred embodiment, plate 41A includes a flange 42 which moves to open and close outlet 21 of tamper resistant container 17. Plate sections 41A, 41B are locked when housing 17 is removed from motor base 29. Locking, unlocking and movement of the plate in this manner provides a secure tamper resistant container 15 which allows controlled dispensing of medicament 27 from the tamper resistant container 15 as will be described in more detail below.

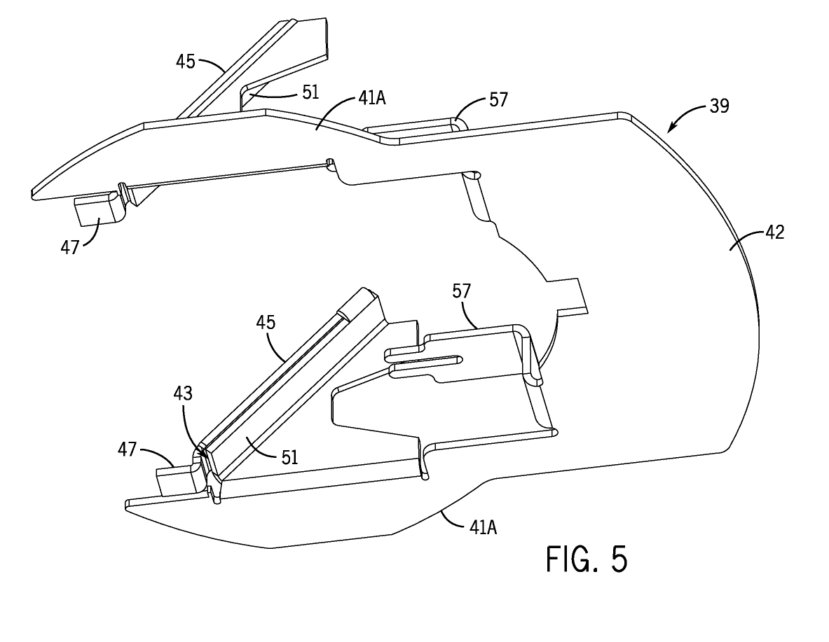

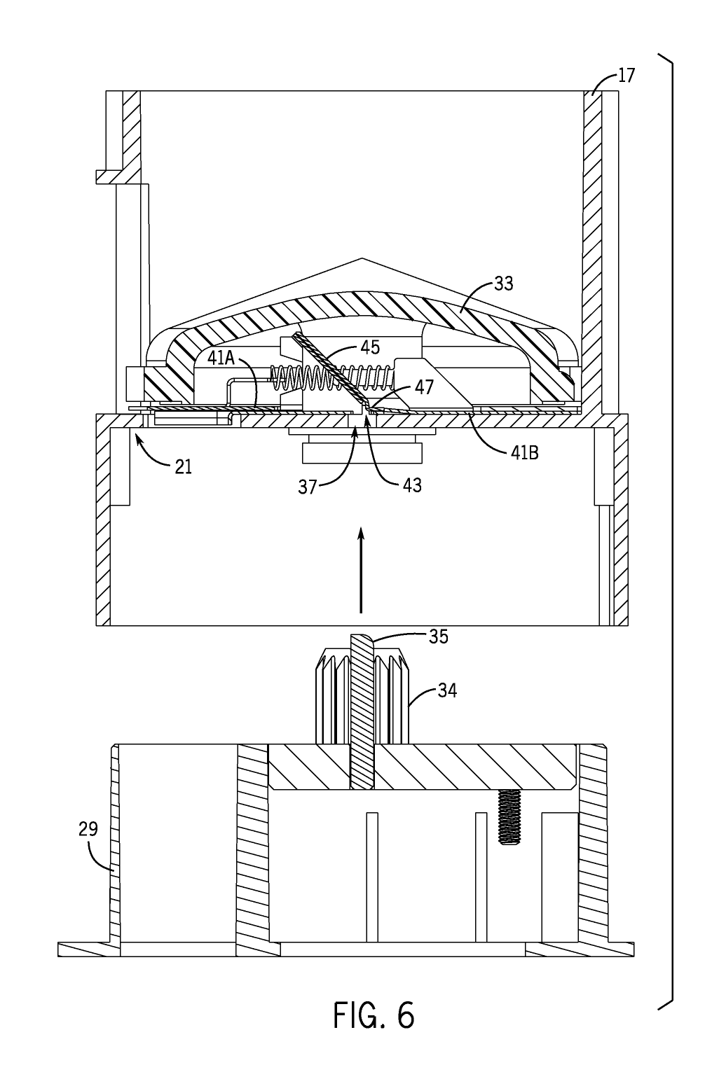

As shown in the embodiment of FIGS. 5-14, a locking mechanism 43 secures plates 41A, 41B in a closed position over outlet 21 when motor base 29 is removed from housing 17 (see FIGS. 6-8 and 12). In the exemplary embodiment shown in the drawings, a lever 45 is included on section 41A and engages section 41B at point 49 when housing 17 is removed from motor base 29 as shown in FIGS. 6 and 12. Such engagement of plate 41A and plate 41B when housing 17 is removed from motor base 29 prevents the opening of outlet 21 thereby preventing any dispensing or access to medicaments 27 in tamper resistant container 15. Lever 45 may be a leaf spring or other flexible member that can flex and disengage from plate 41B when activation pin 35 engages lever 45 through aperture 37 in housing 17.

Plate 41A and plate 41B may be unitary in structure. Further plate 41A, 41B may be formed from a single piece of material. In addition plate 41A, 41B may be formed from metal, polymer, carbon graphite or other suitably strong material. Plate 41A,41B may be formed through 3D printing techniques using suitably strong material, including composite material.

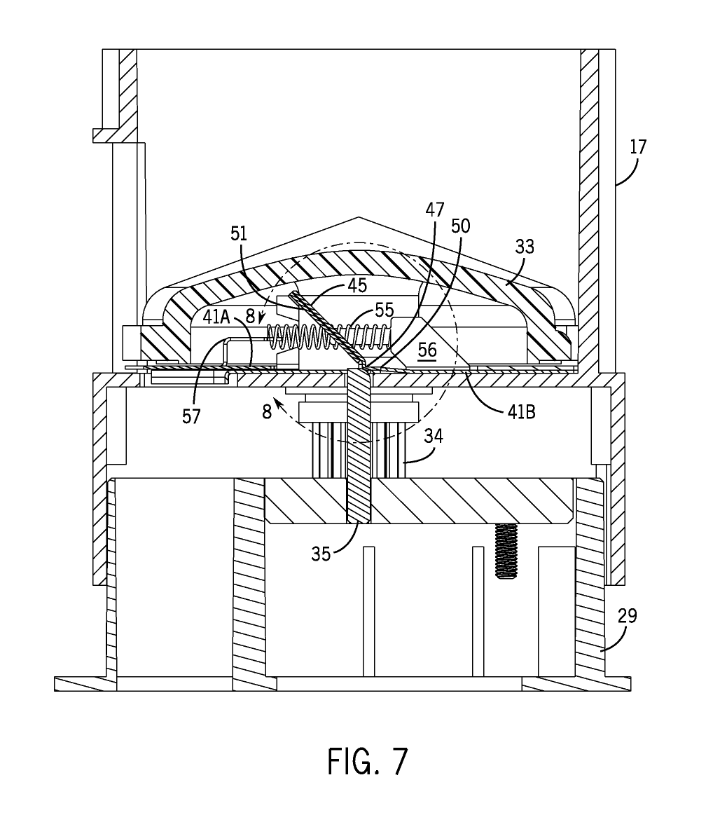

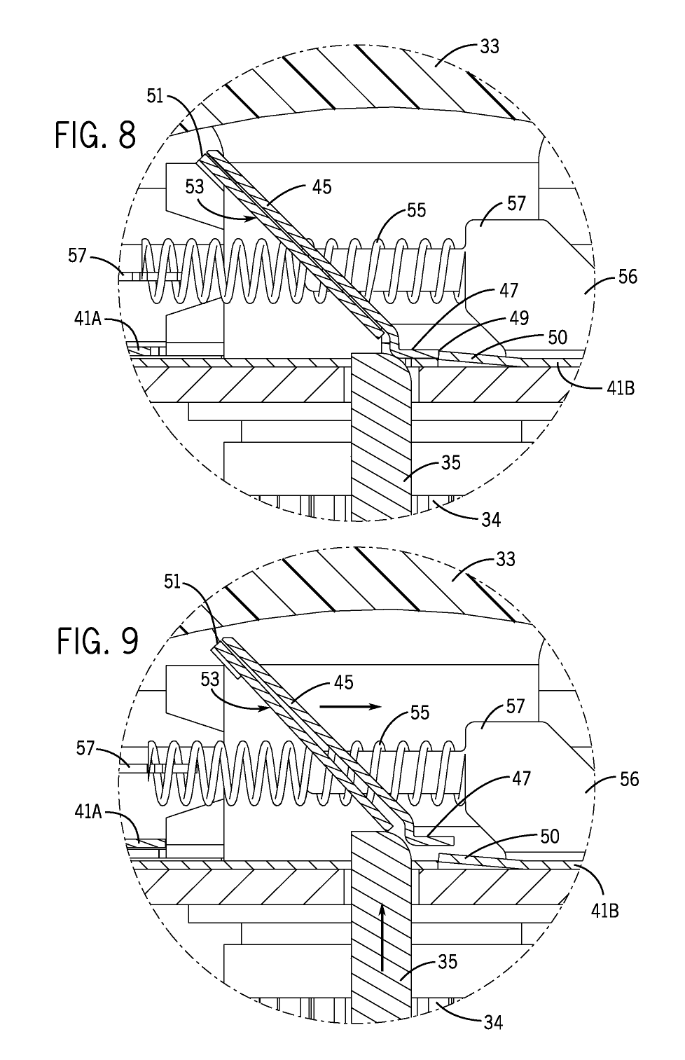

As shown in detail in FIGS. 7 and 8, activation pin 35 on motor base 29 is positioned through aperture 37 to guide activation pin 35 into engagement with one end of lever 45 at arm 47. Upon insertion of motor base 29 into aperture 37, arm 47 moves from abutting plate 41B at point 49 and is released from its locking engagement. When arm 47 is further raised by engagement with activation pin 35, arm 47 will be raised high enough to clear the raised portion 50 of plate 41B releasing plate 41A and allowing plate 41A to slide in a controlled manner. Once arm 47 clears raised portion 50 of plate 41B, plate 41A shifts and slides as activation pin 35 interacts with ramp surface 53 of cam 51. The path of plate 41A is determined by cam 51 with ramp surface 53 which are part of or otherwise fixed to plate 41A.

Spring 55 is positioned between receiver 57 on plate 41A and block 56 on plate 41B. Spring 55 engages receiver 57 on plate section 41A and block 56 on plate 41B to provide a bias to maintain plate 41A in the closed position with respect to plate 41B when motor base 29 is removed from housing 17 as shown in FIGS. 6-9. In the exemplary embodiment shown, when spring 55 is in its unbiased state without any compression or extension, plate 41A is positioned to close outlet 21. In the closed position, medicaments cannot be dispensed from tamper resistant container 15. Upon engagement of activation pin 35 with ramp 53 of cam surface 51 and movement of plate 41A, spring 55 begins to compress. Such compression provides the bias necessary to close plate section 41A when housing 17 is removed from motor base 29. Upon closing plate 41A, lever 45 moves back into position with arm 47 abutting plate 41A at point 49, thereby securing and locking tamper resistant container 15.

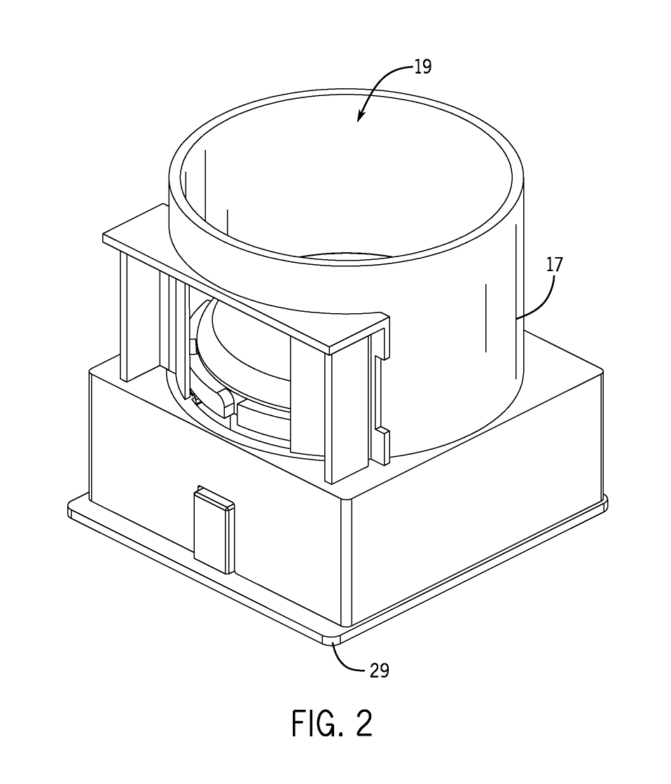

In summary, as illustrated in the preferred embodiment of FIGS. 2-14, operation of the tamper resistant container and method for secure storage and dispensing of objects including medicaments therefrom includes initially moving housing 17 onto motor base 29 such that activation pin 35 moves into aperture 37 and engages lever 45. As activation pin 35 pushes up into aperture 37 activation pin 35 releases arm 47 and begins to follow ramp 53 which functions as a cam to slide plate 41A. As ramp 53 and lever 45 are part of plate 41A, plate 41A moves to open outlet 21 in housing 17 as activation pin 35 follows up ramp 53. Accordingly, as the drive mechanism advances the dispensing mechanism 25, turntable 33 moves to advance medicament 27 into position for delivery through outlet 21, down chute 18 and into vial 20. It will be appreciated that to provide the desired controlled movement of plate 41A, it may be beneficial to include more than one activation pin 35 and cam surface 51 with ramp 53. In the preferred embodiment of FIGS. 1-14, two pins 35, two cam surfaces 51 and two ramps 53 are shown. Other configurations including more than two pins may provide the necessary closing, locking, subsequent release and movement of plate section 41A as described herein.

One skilled in the art will recognize, however, that the disclosure may be practiced without one or more of the specific details, or with other methods, components, materials, and the like. In other instances, well-known structures, materials, or operations are not shown or described in detail to avoid obscuring aspects of the disclosure.

Reference throughout this specification to “the embodiment,” “this embodiment,” “the previous embodiment,” “one embodiment,” “an embodiment,” “a preferred embodiment” “another preferred embodiment,” “an exemplary embodiment,” “example,”or similar language means that a particular feature, structure, or characteristic described in connection with the embodiment is included in at least one embodiment. Thus, appearances of the phrases “in the embodiment,” “in this embodiment,” “in the previous embodiment,” “in one embodiment,” “in an embodiment,” “in a preferred embodiment,” “in another preferred embodiment,” “in an exemplary embodiment,” “in the exemplary embodiment,” “in an example,” “in the example” and similar language throughout this specification may, but do not necessarily, all refer to the same embodiment.

Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments.

The design of the tamper resistant container and method provides for secure storage and dispensing of objects including medicaments, controlled substances and the like. Plate 41A remains positioned and locked over dispensing outlet 21. Plate 41A cannot be moved to open outlet 21 without disengaging locking lever 45 and, specifically, raising arm 47 from abutment point 49 and over plate 41B and raised surface 50 through activation pins 35. The tamper resistant container and method with these locking features meets the regulations of pharmacy boards on federal and state levels. The tamper resistant container and method provide the necessary secure storing, transporting and handling of medicaments, including controlled substances, in secure tamper resistant containers in regulated environments such as prisons, penitentiaries, mental facilities and other governmental institutions.

While the present disclosure has been described in connection with certain exemplary or specific embodiments, it should be understood that the disclosure is not limited to the disclosed embodiments, but, on the contrary, is intended to cover various modifications, alternatives, modifications and equivalent arrangements as will be apparent to those skilled in the art. Any such changes, modifications, alternatives, modifications, equivalents and the like may be made without departing from the spirit and scope of the disclosure.

What is claimed is:

1. A tamper resistant container for secure storage and dispensing of objects therefrom, the container comprising:
a housing having an inlet, an outlet and a lid which opens and closes the inlet;
a dispensing mechanism within the housing to position an object for dispensing from the container;
a base including a drive mechanism;
a pin which cooperates with at least one of the housing and the base;
a moveable plate positioned with respect to the outlet for opening and closing the outlet, the moveable plate being biased in a closed position when the housing is removed from the base, wherein the moveable plate moves to an open position when the housing is positioned on the base and the pin cooperates with the moveable plate to allow an object to be dispensed from the tamper resistant container.

2. The tamper resistant container of claim 1 further comprising a lock to secure the moveable plate in the closed position.

3. The tamper resistant container of claim 2 wherein the lock includes a lever which releases the moveable plate for movement when the pin is engaged with the moveable plate.

4. The tamper resistant container of claim 2 wherein the lock comprises a leaf spring including an arm which releases the moveable plate for movement when the pin engages the arm.

5. The tamper resistant container of claim 1 further comprising a secure lid affixed to the inlet of the tamper resistant container.

6. The tamper resistant container of claim 1 further comprising a lid locked to the tamper resistant container.

7. The tamper resistant container of claim 1 further comprising a cam surface which cooperates with the moveable plate for controllably opening the outlet through movement of the moveable plate.

8. The tamper resistant container of claim 1 further comprising a bias force to maintain the moveable plate in the closed position when the housing is removed from the base.

9. The tamper resistant container of claim 8 wherein the bias force includes a spring which provides controlled closing of the outlet when the housing is removed from the base.

10. The tamper resistant container of claim 1 further comprising a spring which maintains the moveable plate in the closed position when the housing is removed from the base and provides controlled movement of the plate to the open position when the housing is placed onto the base.

11. The tamper resistant container of claim 1 further comprising a spring and a cam surface which cooperate with the moveable plate to controllably open and close the moveable plate with respect to the outlet.

12. The tamper resistant container of claim 11 wherein the spring, the cam surface and the pin all cooperate to position the moveable plate in the open and the closed position.

13. A method of dispensing objects from a secure tamper resistant container comprising:
providing a housing having an inlet, an outlet and a lid which opens and closes the inlet;
providing a dispensing mechanism within the housing to position an object for dispensing from the container;
providing a base including a drive mechanism;
providing a moveable plate positioned with respect to the outlet; and
providing a pin which cooperates with the moveable plate; and
placing the housing on to the base such that the pin allows the moveable plate to move from a closed position to an open position to open the outlet of the tamper resistant container.

14. The method of claim 13 further comprising locking the moveable plate in the closed position.

15. The method of claim 13 wherein locking the moveable plate in the closed position includes providing a lever which secures the moveable plate in the closed position, and further comprising releasing the lever allowing the moveable plate to move from the closed position.

16. The method of claim 13 wherein locking the moveable plate in the closed position includes providing a leaf spring with an arm which releases the moveable plate for movement when the pin is engaged with the arm.

17. The method of claim 13 further providing locking the lid to cover the inlet and secure the tamper resistant container.

18. The method of claim 13 further providing a cam surface which cooperates with the moveable plate providing controllable opening of the outlet through movement of the moveable plate.

19. The method of claim 13 further providing a bias force to maintain the moveable plate in the closed position when the housing is removed from the base.

20. The method of claim 13 further providing a bias force to maintain the moveable plate in the closed position when the housing is removed from the base and to control movement of the plate to the open position when the housing is placed onto the base.

21. The method of claim 13 further providing a spring bias and a cam surface which cooperate with the pin and the moveable plate to controllably move the moveable plate between the closed position and the open position.
